(19) United States
(12) Patent Application Publication
(10) Pub. No.: US 2003/0225841 A1
(43) Pub. Date: Dec. 4, 2003

(54) System and method for preventing spam mails

(76) Inventors: Sang-Hern Song, Daejeon-Si (KR); Ki-Young Baek, Nonsan-Si (KR); Jae-Cheol Ryou, Daejeon-Si (KR); Jong-Hu Lee, Daejeon-Si (KR)

Correspondence Address: PENNIE & EDMONDS LLP, 1667 K STREET NW, SUITE 1000, WASHINGTON, DC, 20006

(21) Appl. No.: 10/309,355

(22) Filed: Dec. 4, 2002

(30) Foreign Application Priority Data
May 31, 2002 (KR) 2002-30827

(51) Int. Cl. G06F 15/16

(52) U.S. Cl. 709/206

(57) ABSTRACT

A system and method for preventing spam mails. A spam mail information collection server extracts base information for spam mail determination from header information of spam mails received at false mail addresses, databases the extracted spam mail determination base information and provides the databased spam mail determination base information to at least one mail server. The mail server receives the spam mail determination base information and stores it in a database. Upon receiving a new mail, the mail server analyzes header information of the received new mail, searches the spam mail determination base information database for the analyzed header information to determine whether the new mail is a spam mail, and blocks the reception of the new mail if the mail is determined to be a spam mail.

### BACKGROUND OF THE INVENTION

1. Field of the Invention

The present invention relates to a system and method for preventing spam mails, and more particularly to a spam mail processing technique that regards as spam mails mails received at mail accounts which are only propagated to bulletin boards, etc. on the Web and not used.

2. Description of the Related Art

An example of conventional spam mail prevention techniques is shown in Korean Patent Laid-open Publication No. 2002-1159 (2002. 01.09), entitled ‘SPAM MAIL PREVENTION METHOD USING GHOST ID’.

In the above method proposed in Korean Patent Laid-open Publication No. 2002-1159, a ghost ID is created and registered, and then managed like a normal ID such that it is exposed to persons that collect IDs for spam mails. Thereafter, if a mail is received, then a destination ID of the received mail is checked to determine whether the mail includes the ghost ID. In the case where it is determined that the received mail includes the ghost ID, a determination is made as to whether the mail is a spam mail. If the received mail is determined to be a spam mail, then it is deleted from a mail server, so the spam mail can be prevented in advance from being sent out.

In other words, in this conventional method, the mail server is adapted to register a ghost ID by itself, determine whether a mail sent to a mail address including the ghost ID is a spam mail, and delete the sent mail if it is determined to be a spam mail.

However, the above-mentioned conventional method is disadvantageous in that spam mails not including a registered ghost ID cannot be prevented, and a plurality of mail servers on a network must individually create and register ghost IDs to process spam mails.

Accordingly, in order to overcome the above problems, this inventor has researched and developed a spam mail prevention system and method wherein a spam mail information collection server is provided separately from a plurality of mail servers supporting mail services, to extract base information for spam mail determination from header information of spam mails received at false mail addresses, database the extracted spam mail determination base information and provide the databased spam mail determination base information to each of the mail servers, thereby preventing an overload on the mail servers and a degradation in working efficiency thereof, which result from the fact that the mail servers individually create and register ghost IDs to process spam mails, and enabling the mail servers to effectively prevent spam mails using the databased spam mail information.

### SUMMARY OF THE INVENTION

Therefore, the present invention has been made in view of the above problems, and it is an object of the present invention to provide a spam mail prevention system and method wherein a spam mail information collection server extracts base information for spam mail determination from header information of spam mails received at false mail addresses, databases the extracted spam mail determination base information and provides the databased spam mail determination base information to each mail server.

It is another object of the present invention to provide a spam mail prevention system and method which can analyze header information of a received new mail, search a spam mail determination base information database for the analyzed header information to determine whether the new mail is a spam mail, and block the reception of the new mail if the mail is determined to be a spam mail.

It is yet another object of the present invention to provide a spam mail prevention system and method which can periodically update the contents of a spam mail determination base information database, search the updated spam mail determination base information database for header information of a previously received mail to determine whether the previously received mail is a spam mail, and delete the previously received mail from a corresponding mail server if the mail is determined to be a spam mail.

In accordance with one aspect of the present invention, the above and other objects can be accomplished by the provision of a spam mail prevention system comprising a spam mail information collection server including a first mail receiver for receiving mails sent to at least one false mail address, an information extractor for extracting base information for spam mail determination from each of the mails sent to the false mail address, received by the first mail receiver, a first database for storing the spam mail determination base information extracted by the information extractor, and a first spam mail information transmitter for propagating the spam mail determination base information stored in the first database over a network; and at least one mail server connected with the spam mail information collection server over the network, the mail server including an updater for periodically receiving and storing the spam mail determination base information from the first database in the spam mail information collection server, a second database for storing spam mail determination base information updated by the updater, a second mail receiver for receiving a new mail sent to an actually used mail address, a header information analyzer for analyzing header information of the new mail received by the second mail receiver and storing the analyzed result in the second database, and a spam mail filter for searching the second database for the analyzed header information of the received new mail to determine whether the new mail is a spam mail, blocking the reception of the new mail if the mail is determined to be a spam mail, searching the second database for stored header information of a previously received mail to determine whether the previously received mail is a spam mail, and deleting the previously received mail from the mail server if the mail is determined to be a spam mail.

Preferably, the mail server may further include a second spam mail information transmitter for transmitting spam mail information, deleted from the mail server by the spam mail filter, to a mail recipient's computer.

In accordance with another aspect of the present invention, there is provided a spam mail prevention method comprising a spam mail information collection routine executable by a spam mail information collection server, the spam mail information collection routine including a mail reception step of receiving mails sent to at least one unused false mail address propagated on the Web, an information extraction step of extracting base information for spam mail determination from each of the mails sent to the false mail address, received at the mail reception step, and a storage step of storing the extracted spam mail determination base information in a first database; and a spam mail processing routine executable by at least one mail server, the spam mail processing routine including an update step of receiving the spam mail determination base information from the spam mail information collection server and storing it in a second database, a header analysis step of analyzing header information of a new mail sent to an actually used mail address, and a spam mail filtering step of searching the second database for the analyzed header information of the new mail to determine whether the new mail is a spam mail, blocking the reception of the new mail if the mail is determined to be a spam mail, searching the second database for header information of a previously received mail to determine whether the previously received mail is a spam mail, and deleting the previously received mail from the mail server if the mail is determined to be a spam mail.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram of a spam mail prevention system in accordance with the present invention;

FIG. 2 is a block diagram showing in detail the construction of the spam mail prevention system in accordance with the present invention; and

FIG. 3 illustrates a preferred embodiment of a spam mail prevention method in accordance with the present invention, wherein:

FIG. 3a is a flow chart illustrating a spam mail information collection routine executed by a spam mail information collection server; and

FIG. 3b is a flow chart illustrating a spam mail processing routine executed by each mail server.

### DESCRIPTION OF THE PREFERRED EMBODIMENTS

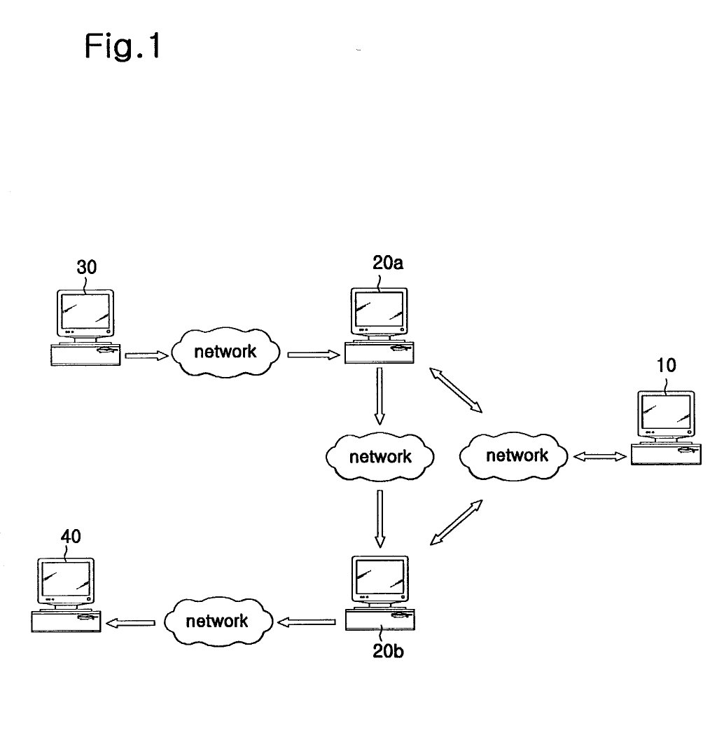

FIG. 1 is a schematic diagram of a spam mail prevention system in accordance with the present invention.

As shown in FIG. 1, the spam mail prevention system according to the present invention comprises a spam mail information collection server 10, and one or more mail servers 20a and 20b for receiving base information for spam mail determination from the spam mail information collection server 10.

In a mail sending operation, a mail is created in a mail sender's computer 30 and sent via the mail server 20a in which the mail sender has been registered. The sent mail is then received at a mail recipient's computer 40 via the mail server 20b in which the mail recipient has been registered.

In the spam mail prevention system according to the present invention, the spam mail information collection server 10 is provided separately from the mail servers 20a and 20b to collect base information for spam mail determination, store the collected spam mail determination base information in a database and provide the stored base information to each of the mail servers 20a and 20b.

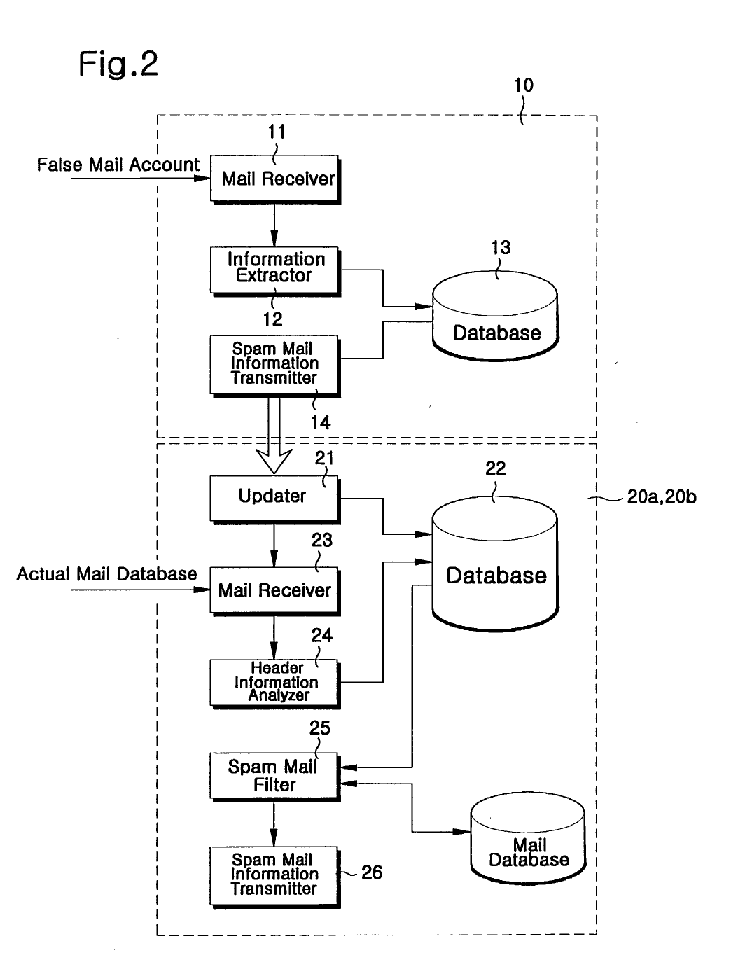

FIG. 2 is a block diagram showing in detail the construction of the spam mail prevention system in accordance with the present invention.

As shown in FIG. 2, the spam mail information collection server 10 of the spam mail prevention system according to the present invention includes a mail receiver 11, information extractor 12, database 13 and spam mail information transmitter 14.

The mail receiver 11 acts to receive mails sent to at least one false mail address.

A manager of the spam mail information collection server 10 creates at least one unused mail account and propagates the created mail account to bulletin boards of various sites over a network.

It is common that a spam mail sender, through the use of a desired spam mail tool, extracts e-mail addresses spread on the Web, stores the extracted e-mail addresses in a database, and sends a desired spam mail to all the e-mail addresses stored in the database, or sells the database storing the e-mail addresses to companies or individuals desiring to send spam mails.

The unused false mail address is typically unknown to business-connected persons. In this regard, almost 100% of mails received at the false mail address can be considered to be spam mails.

The mail receiver 11 receives mails sent to the false mail address propagated on the Web.

On the other hand, the false mail address includes a mail ID provided with a combination of alphanumeric characters in the form of ASCII codes. It is preferable that the mail ID is created by selecting and combining alphanumeric characters in ascending order such that, in an automatic spam mail sending operation by the spam mail tool, a spam mail is sent to the false mail address earlier than other normal mail addresses.

As a result, when a spam mail is automatically sent to the e-mail addresses stored in the database by the spam mail tool, it is sent earlier than other normal mails, so a spam mail filtering operation, which will be described later in detail, can be performed more effectively.

The information extractor 12 acts to extract base information for spam mail determination from each of the mails sent to the false mail address, received by the mail receiver 11.

The spam mail determination base information extracted by the information extractor 12 preferably includes at least one of a spam mail's title, a spam mail sender's mail address and a spam mail sending computer's Internet protocol (IP) address.

On the other hand, the spam mail's title, spam mail sender's mail address and spam mail sending computer's IP address included in the spam mail determination base information may be assigned higher search priorities.

A sent e-mail has header information including a mail's title, a mail sender's mail address, a mail sending computer's IP address, etc., and the information extractor 12 extracts base information for spam mail determination including a spam mail's title, a spam mail sender's mail address, a spam mail sending computer's IP address, etc. from each mail sent to the false mail address.

The database 13 functions to store the spam mail determination base information extracted by the information extractor 12.

The spam mail information transmitter 14 functions to propagate the spam mail determination base information stored in the database 13 over the network.

The spam mail information collection server 10 transmits the spam mail determination base information stored in the database 13 to a client computer, preferably one or more mail servers 20a and 20b, registered as a member through a predetermined member registration procedure, through the spam mail information transmitter 14 periodically or in response to a client's request.

One or more mail servers 20a and 20b, connected with the spam mail information collection server 10 over the network, each include an updater 21, database 22, mail receiver 23, header information analyzer 24, spam mail filter 25 and spam mail information transmitter 26.

The updater 21 acts to periodically receive and store the spam mail determination base information from the database 13 in the spam mail information collection server 10.

The mail servers 20a and 20b are each adapted to request the spam mail information collection server 10 to periodically transmit spam mail determination base information, in order to block or delete spam mails being received or previously received at all accounts of e-mail users using each mail server. If the spam mail information collection server 10 transmits the spam mail determination base information stored in the database 13, then the mail servers 20a and 20b each receive the transmitted spam mail determination base information through the updater 21 and store the received information therein to update the existing information with the received information.

The database 22 functions to store spam mail determination base information updated by the updater 21.

The spam mail determination base information stored in the database 22 is compared with header information extracted from e-mails received at all accounts of e-mail users using each mail server.

The mail receiver 23 functions to receive new mails sent to actually used mail addresses.

That is, the mail receiver 23 receives a mail sent to an actually used mail address of each user according to a mail transfer protocol.

The header information analyzer 24 acts to analyze header information of a new mail received by the mail receiver 23 and store the analyzed result in the database 22.

Each mail server analyzes header information of a mail sent to a mail address of each user, received by the mail receiver 23, through the header information analyzer 24 and stores the analyzed result in the database 22 so that a determination can be made once again on the basis of updated spam mail determination base information at a later time as to whether the received mail is a spam mail.

The spam mail filter 25 acts to search the database 22 for analyzed header information of a received new mail to determine whether the new mail is a spam mail, and block the reception of the new mail if the mail is determined to be a spam mail. The spam mail filter 25 is also adapted to search the database 22 with updated spam mail determination base information for stored header information of a previously received mail to determine whether the previously received mail is a spam mail, and delete the previously received mail from a corresponding mail server if the mail is determined to be a spam mail.

In other words, upon receiving a new mail, the spam mail filter 25 searches the database 22 with spam mail determination base information stored therein for a mail's title, a mail sender's mail address and a mail sending computer's IP address included in header information of the new mail, analyzed by the header information analyzer 24, to determine whether spam mail determination base information corresponding to the header information of the new mail exists among the spam mail determination base information stored in the database 22. If the corresponding spam mail determination base information exists, the spam mail filter 25 determines the new mail to be a spam mail, and then blocks the reception of the new mail. Unless the corresponding spam mail determination base information exists, the spam mail filter 25 determines the new mail to be a normal mail, and then receives and stores the new mail.

Further, when the spam mail determination base information stored in the database 22 is updated, the spam mail filter 25 searches the updated spam mail determination base information for analyzed header information of a previously received mail, stored in the database 22, to determine whether spam mail determination base information corresponding to the header information of the previously received mail exists among the updated spam mail determination base information. If the corresponding spam mail determination base information exists, the spam mail filter 25 determines the previously received mail to be a spam mail, and then deletes it from a corresponding mail server. Unless the corresponding spam mail determination base information exists, the spam mail filter 25 determines the previously received mail to be a normal mail, and then maintains it in its stored state.

The spam mail information transmitter 26 functions to transmit spam mail information, deleted from a corresponding mail server by the spam mail filter 25, to the mail recipient's computer 40.

In other words, when the mail recipient's computer 40 gains access to the mail server 20b under the condition that a spam mail has already been sent to the mail recipient's computer 40 and stored in a mailbox thereof, the spam mail information transmitter 26 transmits spam mail information, deleted from the mail server 20b by the spam mail filter 25, to the mail recipient's computer 40 so that the spam mail stored in the mailbox thereof can be deleted.

In general terms, mails by users stored in the mail server are received at client computers of the corresponding users by a mail reception tool installed and run in each of the client computers, for example, Outlook Express by Microsoft Corporation, and then stored in mailboxes of the client computers. In this connection, spam mails are rarely sent to the client computers of the users.

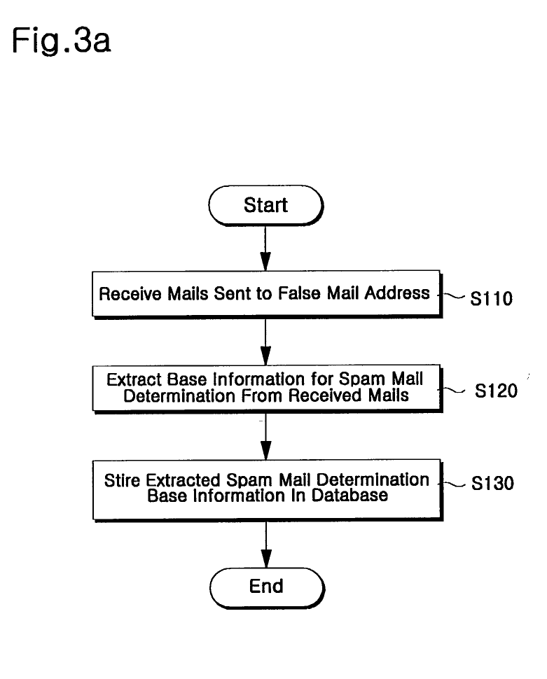

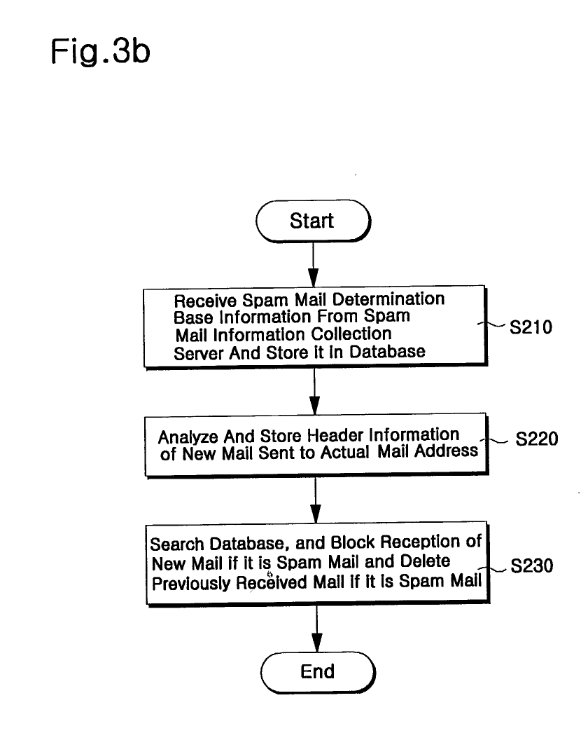

FIG. 3 illustrates a preferred embodiment of a spam mail prevention method in accordance with the present invention, wherein FIG. 3a is a flow chart illustrating a spam mail information collection routine executed by the spam mail information collection server 10 and FIG. 3b is a flow chart illustrating a spam mail processing routine executed by each mail server.

The spam mail information collection routine and the spam mail processing routine are executed independently of each other.

The spam mail information collection routine includes a mail reception step S110, an information extraction step S120, and a storage step S130.

At the mail reception step S110, mails sent to at least one unused false mail address propagated on the Web are received.

That is, spam mails sent to at least one unused mail account propagated to bulletin boards of various sites over a network are received through the mail reception step S110.

At this time, almost 100% of mails received at the unused false mail address can be considered to be spam mails, in that the false mail address is typically unknown to business-connected persons.

On the other hand, the false mail address includes a mail ID provided with a combination of alphanumeric characters in the form of ASCII codes. Preferably, the mail ID is created by selecting and combining alphanumeric characters in ascending order such that, in an automatic spam mail sending operation by a spam mail tool, a spam mail is sent to the false mail address earlier than other normal mail addresses.

Accordingly, when a spam mail is automatically sent to e-mail addresses stored in a database by the spam mail tool, it is sent earlier than other normal mails, so a spam mail filtering operation, which will be described later in detail, can be performed more effectively.

At the information extraction step S120, base information for spam mail determination is extracted from each of the mails sent to the false mail address, received at the mail reception step S110.

A sent e-mail generally has header information including a mail's title, a mail sender's mail address, a mail sending computer's IP address, etc. Base information for spam mail determination, for example, a spam mail's title, a spam mail sender's mail address, a spam mail sending computer's IP address, etc. are extracted from each mail sent to the false mail address, received at the mail reception step S110, through the information extraction step S120.

The spam mail determination base information extracted at the information extraction step S120 preferably includes at least one of the spam mail's title, spam mail sender's mail address and spam mail sending computer's IP address.

On the other hand, the spam mail's title, spam mail sender's mail address and spam mail sending computer's IP address included in the spam mail determination base information may be assigned higher search priorities.

At the storage step S130, the spam mail determination base information extracted at the information extraction step S120 is stored in a database.

In other words, the spam mail determination base information extracted at the information extraction step S120 is stored in the database through the storage step S130 so that it can be transmitted to a client computer, preferably at least one mail server, registered as a member through a predetermined member registration procedure, in response to a request therefrom.

In this manner, the spam mail information collection routine of the spam mail prevention method according to the preferred embodiment of the present invention is executed to receive mails sent to at least one unused false mail address propagated on the Web through the mail reception step S110, extract base information for spam mail determination from each of the received mails through the information extraction step S120, and store the extracted spam mail determination base information in the database through the storage step S130 to transmit the stored spam mail determination base information to at least one mail server in response to a request therefrom.

The spam mail processing routine includes an update step S210, a header analysis step S220, and a spam mail filtering step S230.

At the update step S210, the spam mail determination base information from the spam mail information collection server is received and stored in a database.

Each mail server requests the spam mail information collection server to periodically transmit spam mail determination base information, in order to block or delete spam mails being received or previously received at all accounts of e-mail users using each mail server. If the spam mail information collection server transmits the spam mail determination base information, then each mail server receives the transmitted spam mail determination base information through the update step S210 and stores the received information therein to update the existing information with the received information.

At the header analysis step S220, an analysis is made of header information of a new mail sent to an actually used mail address.

Each mail server analyzes header information of a new mail sent to an actually used mail address through the header analysis step S220 and stores the analyzed result in the database so that a determination can be made once again on the basis of updated spam mail determination base information at a later time as to whether the sent mail is a spam mail.

At the spam mail filtering step S230, the database with spam mail determination base information stored therein is searched for the analyzed header information of the new mail to determine whether the new mail is a spam mail, and the reception of the new mail is blocked if the mail is determined to be a spam mail. Further, the spam mail determination base information database is searched for header information of a previously received mail to determine whether the previously received mail is a spam mail, and the previously received mail is deleted from a corresponding mail server if the mail is determined to be a spam mail.

In other words, at the spam mail filtering step S230, upon receiving a new mail, the spam mail determination base information database is searched for a mail's title, a mail sender's mail address and a mail sending computer's IP address included in header information of the new mail, analyzed through the header analysis step S220, to determine whether spam mail determination base information corresponding to the header information of the new mail exists among the spam mail determination base information stored in the database. If the corresponding spam mail determination base information exists, the new mail is determined to be a spam mail and the reception thereof is thus blocked. Unless the corresponding spam mail determination base information exists, the new mail is determined to be a normal mail, so it is received and stored.

Further, if the spam mail determination base information stored in the database is updated, then it is searched for analyzed header information of a previously received mail, stored in the database, to determine whether spam mail determination base information corresponding to the header information of the previously received mail exists among the updated spam mail determination base information. If the corresponding spam mail determination base information exists, the previously received mail is determined to be a spam mail, so it is deleted from a corresponding mail server. Unless the corresponding spam mail determination base information exists, the previously received mail is determined to be a normal mail, so it remains stored.

Generally, mails by users stored in each mail server are received at client computers of the corresponding users by a mail reception tool installed and run in each of the client computers, for example, Outlook Express by Microsoft Corporation, and then stored in mailboxes of the client computers. In this regard, spam mails are rarely sent to the client computers of the users.

Therefore, by doing so, the spam mail prevention system and method according to the present invention can accomplish the above-presented objects.

As apparent from the above description, the present invention provides a spam mail prevention system and method wherein a spam mail information collection server extracts base information for spam mail determination from header information of spam mails received at false mail addresses, databases the extracted spam mail determination base information and provides the databased spam mail determination base information to each mail server, thereby efficiently preventing the spam mails from propagating without imposing any burden on individual mail servers. Further, the present spam mail prevention system and method can analyze header information of a received new mail, search a spam mail determination base information database for the analyzed header information to determine whether the new mail is a spam mail, and block the reception of the new mail if the mail is determined to be a spam mail. Therefore, any spam mail is blocked so that it cannot be stored in each mail server. Furthermore, the present spam mail prevention system and method can periodically update the contents of the spam mail determination base information database, search the updated spam mail determination base information database for header information of a previously received mail to determine whether the previously received mail is a spam mail, and delete the previously received mail from a corresponding mail server if the mail is determined to be a spam mail. Therefore, spam mails can be deleted from among previously received mails in each mail server, not received yet by mail users.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spam mail prevention system comprising:
a spam mail information collection server including a first mail receiver for receiving mails sent to at least one false mail address, an information extractor for extracting base information for spam mail determination from each of the mails sent to said false mail address, received by said first mail receiver, a first database for storing said spam mail determination base information extracted by said information extractor, and a first spam mail information transmitter for propagating said spam mail determination base information stored in said first database over a network; and
at least one mail server connected with said spam mail information collection server over the network, said mail server including an updater for periodically receiving and storing said spam mail determination base information from said first database in said spam mail information collection server, a second database for storing spam mail determination base information updated by said updater, a second mail receiver for receiving a new mail sent to an actually used mail address, a header information analyzer for analyzing header information of the new mail received by said second mail receiver and storing the analyzed result in said second database, and a spam mail filter for searching said second database for the analyzed header information of the received new mail to determine whether the new mail is a spam mail, blocking the reception of the new mail if the mail is determined to be a spam mail, searching said second database for stored header information of a previously received mail to determine whether the previously received mail is a spam mail, and deleting the previously received mail from said mail server if the mail is determined to be a spam mail.

2. The spam mail prevention system as set forth in claim 1, wherein said mail server further includes a second spam mail information transmitter for transmitting spam mail information, deleted from said mail server by said spam mail filter, to a mail recipient's computer.

3. The spam mail prevention system as set forth in claim 2, wherein said spam mail determination base information extracted by said information extractor includes at least one of a spam mail's title, a spam mail sender's mail address and a spam mail sending computer's Internet protocol (IP) address, said spam mail's title, spam mail sender's mail address and spam mail sending computer's IP address being assigned higher search priorities.

4. The spam mail prevention system as set forth in claim 1, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

5. The spam mail prevention system as set forth in claim 2, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

6. The spam mail prevention system as set forth in claim 3, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

7. A spam mail prevention system comprising a mail server, said mail server including:
an updater for periodically receiving and storing spam mail determination base information from a spam mail information collection server;
a database for storing spam mail determination base information updated by said updater;
a mail receiver for receiving a new mail sent to an actually used mail address;
a header information analyzer for analyzing header information of the new mail received by said mail receiver and storing the analyzed result in said database; and
a spam mail filter for searching said database for the analyzed header information of the received new mail to determine whether the new mail is a spam mail, blocking the reception of the new mail if the mail is determined to be a spam mail, searching said database for stored header information of a previously received mail to determine whether the previously received mail is a spam mail, and deleting the previously received mail from said mail server if the mail is determined to be a spam mail.

8. The spam mail prevention system as set forth in claim 7, wherein said mail server further includes a spam mail information transmitter for transmitting spam mail information, deleted from said mail server by said spam mail filter, to a mail recipient's computer.

9. The spam mail prevention method as set forth in claim 8, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

10. A spam mail prevention method comprising:
a spam mail information collection routine executable by a spam mail information collection server, said spam mail information collection routine including a mail reception step of receiving mails sent to at least one unused false mail address propagated on the Web, an information extraction step of extracting base information for spam mail determination from each of the mails sent to said false mail address, received at said mail reception step, and a storage step of storing the extracted spam mail determination base information in a first database; and
a spam mail processing routine executable by at least one mail server, said spam mail processing routine including an update step of receiving said spam mail determination base information from said spam mail information collection server and storing it in a second database, a header analysis step of analyzing header information of a new mail sent to an actually used mail address, and a spam mail filtering step of searching said second database for the analyzed header information of the new mail to determine whether the new mail is a spam mail, blocking the reception of the new mail if the mail is determined to be a spam mail, searching said second database for header information of a previously received mail to determine whether the previously received mail is a spam mail, and deleting the previously received mail from said mail server if the mail is determined to be a spam mail.

11. The spam mail prevention method as set forth in claim 10, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

12. The spam mail prevention method as set forth in claim 10, wherein said spam mail determination base information extracted at said information extraction step includes at least one of a spam mail's title, a spam mail sender's mail address and a spam mail sending computer's IP address, said spam mail's title, spam mail sender's mail address and spam mail sending computer's IP address being assigned higher search priorities.

13. The spam mail prevention method as set forth in claim 12, wherein said false mail address includes a mail ID with a combination of alphanumeric characters in the form of ASCII codes, said mail ID being created by selecting and combining alphanumeric characters in ascending order such that, in an automatic spam mail sending operation by a spam mail tool, a spam mail is sent to said false mail address earlier than normal mail addresses.

14. A spam mail prevention method comprising a spam mail processing routine, said spam mail processing routine including:
an update step of receiving spam mail determination base information from a spam mail information collection server and storing it in a database;
a header analysis step of analyzing header information of a new mail sent to an actually used mail address; and
a spam mail filtering step of searching said database for the analyzed header information of the new mail to determine whether the new mail is a spam mail, blocking the reception of the new mail if the mail is determined to be a spam mail, searching said database for header information of a previously received mail to determine whether the previously received mail is a spam mail, and deleting the previously received mail from a corresponding mail server if the mail is determined to be a spam mail.
